(19) United States
(12) Patent Application Publication
(10) Pub. No.: US 2005/0177528 A1
(43) Pub. Date: Aug. 11, 2005

(54) Authenticating digital records

(76) Inventor: Jaffer Qamar, San Francisco, CA (US)

Correspondence Address: JAFFER QAMAR, #1, 98 Carvantes Blvd., San Francisco, CA, 94123, US

(21) Appl. No.: 10/776,670

(22) Filed: Feb. 9, 2004

(51) Int. Cl. G06F 17/00

(52) U.S. Cl. 705/404

(57) ABSTRACT

The invention is related to authenticating records, which include images, video and sound recordings, preferably in digital form, of people, pets, events, places, physical objects, processes and methods, services, documents, drawings and artwork. Authentication comprises determining and recording the record's attributes and the record-owner's identifying information, by an independent certifying authority, appending the determinations and attesting the certifier's seal, with date and location stamps, to the original record. More robust authentication entails maintaining the entire augmented record on a secure server in read-only format if requested by the record-owner. Also, if requested by the record-owner, the entire certified record is made accessible to third parties.

### BACKGROUND OF THE INVENTION

Many people are forced to rely on the representations of others (individuals or organizations) with regards to information about themselves, items they wish to sell, pets they wish to sell or give away, children they wish to put up for adoption, services they wish to provide, events that have occurred, places to visit, properties for sale, documents (including drawings, tickets and legal claims) in their possession, sound or video recordings, artwork, plants, or claims about how certain devices or processes work. Many people forgo transaction opportunities or relationships because of potential for and risk of misrepresentation and fraud.

Such fraud has traditionally been mitigated in paper transactions by the use of notary services and secure access to information. That is, generally speaking, people have created and compiled records and then signed them, either under penalty of perjury, or before a notary public. The notary verifies the signature and the signer's identity and certifies with a seal, its name and signature, the date and place of certification, to assure a third party (the recipient of the record) that the signer is the person who he claims to be. The notary does not authenticate the record attributes (or its contents), which is the duty of the signer. To avoid misrepresentation, the certifying authority should add record attributes and the identifying information of the record provider (record supplier). Such information, which is accurate, recent and reliable, protects recipients.

Organizations transacting (dealing) with customers (audience) try to mitigate misrepresentation by building reputations. But, sometimes, even they misrepresent, under stress or when their representative tries to benefit himself rather than promote the organization.

Known methods for authenticating are: (1) Verifying an individual's identity before permitting him access to secure information, a secure server (for example, for voting), or to a secure location. (2) Computer-created files having date and time stamps that show when the records were created. (3) A service-provider verifying the identity of an entity by checking public records and certifying the entity with its seal and a date stamp. (4) A notary public certifying the signature and the identity of the person signing a record by attesting its seal, signature, date and location. (5) A computer-based system verifying a person's signature by digitally matching it with the one on its server and, if needed, extending the certification period.

Some prior art includes a review or a story covered in a magazine, newspaper, TV report, consumer report, or a government agency that investigates people, events, incidents, places, objects, products, services, advertisements, claims and commitments made by my organizations or individuals to customers or their constituents. Determinations made by an independent entity, however, are not initiated by the record-owner (record-provider) and, when they are, the final record (including the determinations made by the independent entity) is not the property of the record-owner. The investigating entity owns its determinations and the final record it produces.

Prior art only partially protects the recipient or certifies that an effort was made to validate the owner's (supplier's or the organization's) identity. However, the aforementioned methods do not rigorously certify a record so that the recipient receives better information about the record attributes and the owner's identity, thus more thoroughly preventing misrepresentation and fraud.

Moreover, the victim of fraud or the party accused thereof may be deficient in the ability to assert his rights, or defend such charges of fraud, by the absence of certified records with record attributes and/or more information, the parties identify to substantiate or refute such charges.

There is significant potential for misrepresentation by the record-provider and a need for improvements to authenticate records rigorously.

Some service-providers authenticate computer records or records captured by a computer, such as, emails and faxes, with digital date and time stamps. The records are maintained in read-only format so that their contents and attributes cannot be altered. The method does not authenticate record-attributes nor does it add the owner's (supplier's) identifying information to the record. One can change the date and time stamps by resetting the computer's internal clock and, therefore, the method is unreliable. For greater reliability, the record is sent to a service-provider to attest its seal, date and time stamps and saved in a read-only format. The certified record is then sent to the owner and/or to third parties, at the owner's request. The service-provider maintains a copy, on its secure server, and can transmit it to a third party, later, at the owner's request.

Alternatively, a service-provider licenses its software, which adds a digital seal, date and time stamps to a record stored on a computer. Date and time stamps, however, are not obtained from the computer's memory but accessed from a secure server. When a record is maintained only by the owner, its authentication is less reliable because a software hacker can alter the record or change the date and time stamp. A record is more reliable when it's maintained on a secure server (preferably, the server of the service-provider, but not necessarily).

[The prior art does not express the need nor teach which record attributes and which identifying information, of the record-owner (including a supplier of product or service), the service-provider determines and appends to the original record. There is a need for a method to determine record attributes and add the owner's identifying information to the record before certifying it.]

Some firms selling items on the Internet use another method of certification. For example, in 2003, “ebay” started requiring sellers of air, lodging, cruises and vacation packages to register with a seller-verification and dispute-resolution company. Before listing travel items, sellers must verify their firm's name, contact information and location with “SquareTrade”, which permits registered sellers to display the “SquareTrade” seal next to their items listed for auction. Unfortunately, unregistered sellers can copy the seal and abuse it. (“ebay” does not permit individuals to sell vacation packages.)

Thus, there is a need to examine items—such as, unused, transferable vacation packages—and determining if any restrictions apply and adding an item's attributes to its image before authenticating the entire record and posting the augmented record on the Internet. Items authenticated in the prescribed manner can be listed for sale on any website—not just on eBay. The augmented record has a record-number associated with it for locating and viewing the image of the item with the accompanying objective information, including date and time stamp, by accessing it from the service-provider's secure server.

The prior art mostly relates to authenticating the identity of a person wanting access to secure data, a website, a secure server where he can perform or execute certain tasks, or to a physical location. Some of the art relates to digitally matching a person's biometrics with the information that is on the certifying authority's secure server. Other prior art requires an individual to provide password(s), key(s) and other confidential information—such as, the person's place and date of birth or mother's maiden name—before permitting access to a secure server or to a place. The art does not express a need to protect a third party from receiving misrepresented information.

It is an object of this invention to reduce misrepresentation and conflict between the record-provider (including information about products and services offered by organizations) and recipients.

It is a further object of this invention to provide information to protect recipients (saving them time and money and reducing their risks) so that they make decisions based on the most recent, accurate, reliable and complete information.

It is also an object of this invention to protect record-owners by providing a method to authenticate their records so that they may assert their rights, after certification, in situations of conflict.

Still a further object of this invention to remove the owner's (supplier's) bias from merchandise (object) attributes, occurrences at an event, or personal characteristics.

It is an additional object of this invention to enhance trade and economic activity by improving the quality and the quantity of information that is available via the Internet or that is provided to recipients by other means.

Another object of this invention is to provide multiple means for confirming the authenticity of records, which are sent to or accessible to third parties.

Yet another object of the invention is to provide a means for sharing very personal information only with others willing to share and exchange the same information, wherein each party to the exchange is assured that the information they receive is genuine and not merely to secure their personal information.

Still another object of the invention is to permit multiple parties to work independently or in cooperation to provide the entire service instead of it being supplied by a single service-provider. For example, party A determines the objective attributes of the original record. Party A or B determines the identifying information of the record-owner (record-provider). Party A, B or C records the determinations into a form-like data structure. Party A, B, C or D maintains the entire record, including the determinations, on a secure server.

It is an object of the invention that the method be used for authenticating records, documents and information about products and services provided by organizations and individuals.

It is also an object of the invention to authenticate representations made by individuals about their personal characteristics, attributes, skills and qualifications and work related experience.

It is also an object of the invention to authenticate an original record, which is an integrated production of one or more of sound, text, video, drawings and images of one or more of: an event, place, service, process, procedure, or object and the attributes include one or more of relevant descriptions and or measurements of: the event, place, service, process, procedure, or object, expressed by writing, drawing, displaying, and speaking or acting by the service-provider.

### SUMMARY OF THE INVENTION

The first and other objects of the invention are accomplished by utilizing a certifying authority to create, store, control and grant access to the first party's desired records or information in a digital format, making them selectively accessible to a third party. Such certifying authority in a first instance certifies the identity of the record-owner and validates his signature. The certifier also determines record attributes and the owner's identifying information and maintains the certified record, in read-only format, on a secure server. The record is either directly accessible to a third party (for example, via the Internet) or the service-provider can provide confirmation to a third party whether or not the record certified by it is authentic. Servers accessible via the Internet are vulnerable to malfunctions, to the service-provider's agents, to outside computer hackers and to virus attacks. Secure servers not accessible via the Internet are only vulnerable to malfunction and to the agents who are able to penetrate the security shield without authorization.

In other aspects, deployment of the instant inventions involves one or more of the following steps in creating and using a secured record: (1) Determining and adding record attributes—such as, form, dimensions, specifications, expected use, and color—to the record, to the extent possible. (2) Adding the owner's (supplier's) identifying information; to the extent it is relevant. (3) Certifying the entire record, including the information determined added by the certifying authority, with a seal, a record-number, date and time, and location stamps. (4) Maintaining the entire record on a secure server. (5) Providing a means for a third party to access the entire record and be confident that it's authentic or providing a means for confirming whether the record received by a third party is authentic.

Deployment of the instant invention protects and certifies to a recipient that the record is authentic by providing useful information about the record and its owner along with information about when and where the record was created and certified.

Application of the invention avoids misrepresentation and conflict between the record-provider and recipients by inserting a service-provider between the two parties who adds objective information to the original record before certifying it. The certified record is more reliable, accurate and current.

The receiving parties are protected, as well as save time and money, able to make decisions based on the most recent, accurate, reliable and complete information by using a service-provider who informs the public what sort of identifying information it tries to determine or seek from a record-owner (or from the supplier of information). For example, the certifier determines age, qualifications (degrees and institutions attended and organizations employed at), weight, height, race, hair and eye colors, skin complexion, baldness, name, signature and address when making determinations of a person. When determining the identifying information of a firm, the certifier seeks the business name, address, contact person, phone and fax numbers, email address, web address, where it's registered (incorporated), primary business function, the industry that it serves, and other relevant information. Over time, the list of attributes and identifiers can be enhanced or revised.

Service-providers determine the attributes of a person, organization, pet, object, place, event, documents, art, process, etc. They document their determinations, which are verified against the record-owner's driver's license, passport, registration papers or by searching public databases, or by measuring the owner.

People may choose not to provide personal information. In such a case, the service-provider records that the customer opted out. The recipient can then make his own inference about the record-provider's motives. If some information is not available, it is recorded as N/A.

The objective of removing the owner's (supplier's) bias from the record attributes is accomplished, assuring objective information, by using a service-provider to make an unbiased determination. If the owner (supplier) does not agree with the determinations, he may seek a different service-provider.

The object of providing multiple means for confirming the authenticity of records for third parties by having the service-provider issue a record-number at the end of the certifying process. It is used to locate the record on the server. At customer's request, a record-address where a third party can access, scrutinize and verify the record's authenticity is also provided. For example, an ad in a newspaper or on a website may have the URL (Universal Resource Locator) address where an interested third party can view the authenticated record. The URL address can be typed into the address-field of a web-browser running on a computer to cause the entire augmented record to appear on the computer's monitor.

The above and other objects, effects, features, and advantages of the present invention will become more apparent from the following description of the embodiments thereof.

### NOVELTIES OF THE INVENTION

It is an important aspect of the invention that the party determining the record attributes and the identifying information of the record-owner is different from the party owning and supplying the record and ultimately owning the entire record, including the certifier's determinations. Specifically, a record-owner requests a certifier to make determinations and append them to the original record and certify the entire record. The entire certified record is solely and entirely owned by the record-provider—not by the certifier.

The elements, which distinguish the invention from the prior art, follow. First, the certifier and the record-owner are distinct parties. Second, the certifier's determinations become part of the final certified record. Third, the entire record is maintained on a secure server, in read-only format.

### DESCRIPTION OF THE INVENTION

Examples of the invention are as follow. People post personal ads with their photos on matchmaking sites or in newspapers. Some provide pictures of pets for sale or to give away. Others provide pictures of items for sale. Some misrepresent information—such as, age, qualifications (degrees and institutions attended and organizations employed at), weight, and height—or provide an old photo. Alternatively, they exaggerate their own attributes or the attributes of the items for sale. Viewers do not know if the photo was brushed, if it is an old photo, or if the person's attributes or the identifying information are accurate. Some people pretend to be young and friends of children. They misguide the children in to a meeting or indulging in inappropriate behavior. If people were required to post certified information and photos on social websites, then exploiters would be deterred.

Further, persons may be reluctant to post very personal information about themselves such as pictures, likes and dislikes, unless they are assured anonymity until a selected condition is met, which may include the willingness of another party to exchange the same information about themselves.

Photos of people, pets, places and objects, recordings of events and processes, and documents are maintained on various recording media and/or servers. Some records, including video and sound recordings, are accessible via the Internet but are not well authenticated. The present invention describes a method for rigorously certifying records and maintaining them on secure servers, which can be made accessible to third parties.

Alternatively, a copy of the certified record that the service-provider gives to the customer (or a replica of the copy) can be sent to a recipient. The recipient may then submit it to the service-provider to find out if the record he received matches the one that is on the service-provider's secure server. The record is located by using the record-number, which is part of the certified record. The original record is then digitally matched to the copy submitted in order to determine its authenticity.

Alternatively, one or more certifying authorities can act as escrow agents for parties who wish to exchange information only upon assurance that they receive a genuine record from the other party of the same information exchanged. When the parties agree to exchange information they provide the other party with a key or code unique to their records. Each party then provides the service provider holding the record(s) with the key to the other party's record and their own key. The service-provider only releases the information in the record to the requester when both parties have made the request. Thus making their own information available for release and the provider has validated that genuine authentic records exist for both parties.

In any case, the records may be encrypted with a digital encryption key that the parties also exchange, but that the record holder does not possess. This eliminates the record holder, or a person having access to the record holder's system, from unauthorized viewing or release of the records. In creating such encrypted record the party has sole access to a secure private facility provided by the record holder, or their agent, and deploys or enters a password or other encryption key at the time they create the record in the secure facility, thus the key is known only to the record creator.

In a preferred embodiment, a customer asks a licensed or a reputable service-provider to snap his photograph. The service-provider takes a digital photo, determines the customer's attributes—such as, age, qualifications (degrees and institutions attended and organizations employed at), gender, race, height, weight, hair and eye color, baldness, whether the person wears spectacles or uses hearing aid, whether the person has a speech impediment, and skin complexion—and appends the determinations and the customer's identifying information—such as, name and address—to the record and attests its seal with a record number, date, time and location stamp to the original record.

In other embodiments, the certifying authority's seal is not used but instead the entire record (including the attributes and the record-provider's identifying information) is maintained on a secure server.

In yet other embodiments, the customer is granted access to a secure facility for recording their own picture (s), with the service provider only identifying the person or things granted access to the secure facility. Specifically, the method comprises the following steps, which are executed by at one of the service-provider and the customer:

A. Creating the original record.

B. Converting it to digital format, if necessary.

C. Determining the record attributes. For example, for people, the attributes are weight, race, height, gender, hair and eye color, and skin complexion. For products, the attributes are form, color, dimensions, expected use and benefits of the product, durability and other attributes.

D. Determining the owner's identifying information. For a person, the identifying information is name, age and address. For an organization, offering a product or service, the identifying information is business name, address, contact person, phone and fax numbers, email address, web address, place of registration (incorporation), primary business function, the industry that it serves, and other relevant information.

E. Recording the determinations (attributes and the identifying information) by appending them to the original record.

F. Saving the entire record on a secure server in read-only format.

G. Adding a record-number, date, time, and location stamps, service-provider's I.D. #, and the name of the person executing the method.

H. Certifying the entire record by attesting it with the service-provider's seal.

I. Maintaining the entire record on a secure server. And,

J. providing a copy of the entire record to the customer on a recording medium that is preferred by the customer.

If he customer requests that the record be maintained on a server that's accessible to third parties, via the Internet, the method further comprises an additional step, denoted K, providing a record-address (for example, a URL address) to access the record.

The owner gives the record-address to a third party interested in accessing the record. Since the record is maintained on a secure server, when the third party accesses it he feels assured that the record is authentic. He benefits from the information appended to the record by the service-provider. The service-provider's seal is in the form of a digital certificate or other encrypted code or indicia that reliably verifies the provider and prevents the impersonation thereof.

If the record is not accessible via the Internet, the recipient may submit the record to the service-provider to confirm its authenticity. The original certified record is located on the secure server, using the record-number, and it is verified whether the submitted copy is authentic by matching it to the one on the server.

If the customer wants the record to be limited to a select few people, the method further comprises an additional step, denoted as L, in which the service-provider issues a password, or the customer creates the password so that it is not known by the service provider; the password being required for accessing the secure server and the authenticated record.

An alternate embodiment authenticates a video recording created by the service-provider. The method comprises executing steps A)-J), or A)-K) if the recording is to be accessible via the Internet, or steps A)-L) if the access is to be restricted.

An alternate embodiment authenticates a sound recording. Instead of viewing it, it is heard and instead of displaying it, it is played. In a more preferred embodiment, the method comprises executing steps A)-J), or A)-K) if the recording is to be accessible via the Internet, or steps A)-L) if the access is to be restricted.

An alternate embodiment authenticates a photo or a video recording of a pet. The method comprises executing steps A)-J), or A)-K) if the recording is to be accessible via the Internet, or steps A)-L) if the access is to be restricted. In step C), the service-provider determines the attributes of the pet—not of the record-owner. As a non-limiting example, the original record is optionally a photograph of a pet and the attributes in the more preferred embodiments include a combination of color, markings, hair length, plumage, gender, length, height and weight and the approximate age of the pet, and the like.

Another alternate embodiment authenticates a document (for example, a drawing or a dissertation) that is in analog (printed) or digital format. The service-provider creates or examines the document and authenticates it. The method comprises executing steps A)-J), or A)-K) if the recording is to be accessible via the Internet, or steps A)-L) if the access is to be restricted. In step C), the service-provider records the document attributes—such as, file-size, file-name, title, abstract, keywords, table of contents, list of figures, charts and tables, subject and categories under which it is listed and its format. In step D), some identifying information about the owner is not relevant and so the service-provider types N/R for the attributes that pertain to the customer.

Another embodiment authenticates a photo of an item that the customer wishes to sell. He brings the item to the service-provider and the method comprises executing steps A)-J) or B)-J) if the service-provider accepts the photo submitted by the customer. If the customer wants to post the photo on the Internet, the method comprises executing step K) and also step L) if access is to be restricted. In step C), the service-provider records as many attributes of the item, as deemed relevant and useful, by examining it. In step D), some of the identifying information about the customer is not relevant and so the service-provider types N/R in the database for the customer's personal attributes.

For yet another embodiment, the customer requests the service-provider to witness and record (a) an event; (b) a place; (c) a process (or a procedure); or, (d) an object that can't be brought to the service-provider. The method comprises creating an integrated record, which may include photos, video and sound recordings, text and drawings; and, executing steps A)-J), or steps A)-K) if the integrated record is to be accessible via the Internet, or steps A)-L) if the access is to be restricted. Step C) comprises adding descriptions and measurements—such as, the mood, smell, texture, dimensions, and color—to the original record, expressed by writing, drawing, displaying, speaking or acting. The entire record is compiled in text, image, video and sound formats. For step D), some of the customer's identifying information is not relevant and so the service-provider types N/R in the record wherever applicable.

Since a service-provider has fast transmission lines, large storage capacity on its servers and technical expertise, customers may request it to access records from a computer (possibly at a remote location). The method further comprises adding the record attributes—such as: whether it's an executable application and, if so, its intended use, a sound or video recording, a document, an image, alphanumeric data and, if so, its intended use; and adding other relevant information about the quality of the record and the record-size; address of where the record was accessed from; the date and time of access; attesting the service-provider's seal to the record; and maintaining the full record on a secure server and on a portable recording medium for customer's use, as requested by the customer.

Other embodiments of the invention applicable to using a dating service include methods wherein the service-provider authenticates a record of the person seeking to subscribe to a dating service by forming the original record using a template type form containing multiple fields, which the service-provider fills; the form fields corresponding to various attributes for example age, qualifications (degrees and institutions attended and organizations employed at), height, weight, gender, race, measurements of chest, waist and hip circumference, eye and hair color, facial hair, baldness, whether the person wears spectacles, or requires hearing aid, whether the person has speech impediment, skin complexion, and the like.

In other embodiments the original record is a drawing, artwork or one or more photograph of an item, including a three dimensional digital representation of the item, and the like.

In further embodiments the original record is an integrated production of at least one or more of sound, text, video, drawings and images depicting or capturing a place, event or process, including a procedure, and the attributes include one or more of relevant descriptions and measurements of the event, expressed by writing, drawing, displaying, speaking or acting by the service-provider.

In yet other embodiments, the record may include any executable application to display images, sound and/or video recording; document; image; alphanumeric record and its most likely use; as well as characteristics describing the record size; where it was accessed; and, the date it was accessed.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method for authenticating records by a second party (service-provider) for a first party (record-owner) comprising:
a) obtaining a record by at least one of
i) creating an original record, and
ii) accessing a record from a server (or from an archive), and
iii) accepting a record from the first party;
b) determining and recording the record's attributes;
c) appending the attributes recorded in step (b) to the record;
d) adding a date stamp to the record;
e) attesting the entire record, including the appended determinations, with the service-provider's seal;
f) providing the entire record in read-only format to at least one of the first party (record-owner) and a third party (a record-recipient).

2. A method for authenticating records by a second party (service-provider) for a first party (record-owner) comprising:
a) obtaining a record by at least one of
i) creating an original record, and
ii) accessing a record from a server (or an archive), and
iii) accepting a record from the record owner;
b) determining and recording the record's attributes;
c) appending the attributes recorded in step (b) to the record;
d) adding a date stamp to the record;
e) converting the portion of the record not in digital form, to digital form;
f) maintaining the entire record, including the appended determinations, in read-only format, on a secure server.

3. A method as in claim 2, which further comprises providing the entire record to at least one of the first party (record-owner) and a third party (record-recipient).

4. A method as in claim 2, which further comprises the second party (service-provider providing a record-address for accessing it from the secure server.

5. A method as in claim 4, which further comprises the second party (service-provider) providing a password for accessing it from the secure server.

6. A method as in claim 4, wherein the secure server is accessible via the Internet and the record-address is a Universal Resource Locator.

7. A method as in claim 1, which further comprises the second party (service-provider) charging a fee for determining the record's attributes.

8. A method as in claim 2, which further comprises the second party charging a fee for making determinations of the record attributes.

9. A method for authenticating records by a second party (service-provider) for a first party (record-owner) comprising:
a) obtaining a record by at least one of
i) creating an original record, and
ii) accessing a record from a server (or some archive), and
iii) accepting a record from the first party;
b) determining the record's attributes;
c) adding a date stamp to the record;
d) providing the entire record in read-only format to at least one of the first party (record-owner) and a fourth party (attributes-recorder).

10. A method as in claim 9, which further comprises the second party (service-provider) attesting the entire record, including the determinations, with its seal.

11. A method for recording the original record provided by the first party, and the said determinations in claim 9, made by the second party, into a data structure or a form-like medium.

12. A method for maintaining the entire said record in claim 11, on a secure server and providing a record-address for accessing the entire said record.

13. A method as in claim 1, wherein said step of determining the record's attributes by the second party (service-provider) further comprises determining the identifying information of the first party (record-owner).

14. A method as in claim 2, wherein said step of determining the record's attributes by the second party (service-provider) further comprises determining the identifying information of the first party (record-owner).

15. A method where a second party (service-provider) authenticates a record of the person (first party) seeking to subscribe to a dating service, and the original record is the first party's photograph or a video recording and/or sound, and the second party determines one or more attributes selected from the group consisting of name, age, qualifications (degrees and institutions attended and organizations employed at), height, weight, gender, race, measurements of chest, waist and hip circumference, eye and hair color, facial hair, baldness, skin complexion, address, city, state and country of residency, citizenship and U.S. residency status, whether or not the person wears spectacles or lenses as shown or stated on a photo ID, has speech impediment or requires a hearing aid. The second party attests its seal and date, and perhaps also a location stamp, to the original record, appended with the certifier's determinations.

16. A method for recording the said determinations in claim 15 and the original record provided by the first party into a data structure or a form-like medium.

17. A method for maintaining the entire said record in claim 16 on a secure server and providing a record-address for accessing it.

18. A method as in claim 17, which further comprises providing a password for accessing the record from the secure server.

19. A method where the original record is a photograph or a video recording of a pet, and the second party determines one or more attributes selected from the group consisting of color, markings, hair length, plumage, gender, length, height and weight, and the approximate age of the pet. The second party attests its seal and date, and perhaps also a location stamp, to the original record, appended with the certifier's determinations.

20. A method for recording the said determinations in claim 19 and the original record provided by the first party into a data structure or a form-like medium.

21. A method for maintaining the entire said record in claim 20 on a secure server and providing the record-address for accessing it.

22. A method as in claim 1, wherein the original record is advertisement, specifications, a catalog listing, or a posting for a product or service offered by the first party.

23. A method as in claim 2, wherein the original record is advertisement, specifications, a catalog listing, or a posting for a product or service offered by the first party, which further comprises the second party (service-provider) providing a record-address for accessing the entire record from the secure server.

24. A method where the first party (an entity offering a product or service) provides the original record (specifications, claims or advertising material) and requests the second party (an independent certifier) to objectively determine the record attributes and the identifying information of the record-owner (record-provider).

25. A method for recording the said determinations in claim 24 and the original record provided by the first party into a data structure or a form-like medium.

26. A method for maintaining the entire said record in claim 25 on a secure server and providing the record-address for accessing it.

27. A method as in claim 1, wherein the original record is a document and step (b) comprises determining and recording one or more attributes selected from the group consisting of file-size, file-name, title, abstract, keywords for search, table of contents; list of figures, charts and tables; subject and categories under which the document can be searched; and the document's format.

28. A method as in claim 2, wherein the original record is a document and step (b) comprises determining and recording one or more attributes selected from the group consisting of file-size, file-name, title, abstract, keywords for search, table of contents; list of figures, charts and tables; subject and categories under which the document can be searched; and the document's format.

29. A method as in claim 1, wherein the original record is a drawing or artwork.

30. A method as in claim 2, wherein the original record is a drawing or artwork.

31. A method as in claim 1, wherein the original record is an integrated production of one or more of sound, text, video, drawings and images of one or more of: an event, place, service, process, procedure, or an object and the attributes include one or more of relevant descriptions and or measurements of: the event, place, service, process, procedure, or object, expressed by writing, drawing, displaying, and speaking or acting by the service-provider.

32. A method as in claim 2, wherein the original record is an integrated production of one or more of sound, text, video, drawings and images of one or more of: an event, place, service, process, procedure, or object and the attributes include one or more of relevant descriptions and or measurements of: the event, place, service, process, procedure, or object, expressed by writing, drawing, displaying, and speaking or acting by the service-provider.

33. A method as in claim 1, wherein the record attributes in step (b) are selected from the group consisting of the format of: an executable application and the application's most likely use; sound or video recording; document; image; alphanumeric record and its most likely use; record size; where and when the record was accessed.

34. A method as in claim 2, wherein the record attributes in step (b) are selected from the group consisting of the format of: an executable application and the application's most likely use; sound or video recording; document; image; alphanumeric record and its most likely use; record size; where and when the record was accessed.

35. A computer-readable medium having stored thereon a data structure comprising:
a) a first data field having the original record;
b) a second data field having one or more record attributes;
c) a third data field having the date the record is certified;
d) a fourth data field having the identifying information of the first party (record-owner or record-provider);
e) a fifth data field having one or more of the identifying information and the seal of the second party (service-provider) making the determinations of the record's attributes.

36. A computer-readable medium according to claim 35 further comprising a sixth data field for designating that the data structure is read-only.

37. A computer-readable medium according to claim 35 further comprising a sixth data field containing a password to access the record.

38. A computer-readable medium having stored thereon a data structure according to claim 35 wherein the record attributes in the second data field are in encrypted format.

39. A computer-readable medium according to claim 35 further comprising a sixth data field having an access code for retrieving data in one or more of the other data fields.

40. A computer-readable medium according to the 35 wherein the data recorded in the second data field is selected from a group consisting of image data, sound data and alphanumeric data.

41. A computer-readable medium according to claim 35 further comprising a data field (which could be part of another data structure but is linked to the said data structure of claim 35) having fee information that the second party (service provider making the determinations) charges the first party (record-owner or record-provider).

42. A set of application program interfaces embedded on a computer-readable medium for execution on a computer in conjunction with an application program that:
a) identifies records held on a secure server controlled by a second party and deposited by a first party, in response to a request for access by a third party having a key provided by the first party,
b) identifies records held on a secure server controlled by a second party and deposited by the third party, in response to a request for access by the first party having a key provided by the third party,
c) after confirming that the both the first party and third party have released authentic keys to each other:
i) releases the record deposited by the first party to the third party, and
ii) releases the record deposited by the third party to the first party.

43. A computer-readable medium having computer executable instructions for performing a method which comprises:
a) accessing a record from one or more of another computer or another computer-readable medium;
b) determining and recording the record's attributes;
c) appending the determinations in step (b) to the original record;
d) adding a date stamp;
e) saving the entire record, including the determinations, in read-only format.

44. A method claim according to claim 43 that further comprises attesting the entire record, including the appended determinations, with one or more of the service-provider's seal and its identifying information.

45. A claim according to claim 43 that further comprises maintaining the record, including the appended determinations, on a secure server.

46. A claim according to claim 45 that further comprises providing a record-address to access the record.

47. A claim according to claim 46 that further comprises providing a password to access the record.
